(19) United States
(12) Patent Application Publication
(10) Pub. No.: US 2026/0006273 A1
(43) Pub. Date: Jan. 1, 2026

(54) METHOD FOR AUTOMATED MODERATION OF CHILD-INAPPROPRIATE VIDEO CONTENT

(71) Applicant: VIETTEL GROUP, Ha Noi City (VN)

(72) Inventors: Thi Hanh Vu, Hai Phong City (VN); Ngoc Anh Nguyen, Ha Noi (VN); Hong Phuc Vu, Thai Binh (VN)

(73) Assignee: VIETTEL GROUP, Ha Noi City (VN)

(21) Appl. No.: 18/952,953

(22) Filed: Nov. 19, 2024

(30) Foreign Application Priority Data
Jun. 28, 2024 (VN) 1-2024-04797

(51) Int. Cl. H04N 21/25; G06Q 50/00; G06V 10/82

(52) U.S. Cl. CPC H04N 21/25; G06Q 50/01; G06V 10/82

(57) ABSTRACT

The invention mentioned a method for automated moderation of child-inappropriate video content. The method includes the following steps: step 1: collecting and labeling video data on children-inappropriate content; step 2: data preprocessing; step 3: building a model to identify the time intervals of the appearance of children-inappropriate objects; step 4: building a model to identify the time intervals of the occurrence of children-inappropriate behaviors/actions; step 5: building a model to identify the age of the subjects based on their face appearing in the frames; step 6: post-processing the output information to produce censorship results; step 7: optimizing model performance to reduce video processing time for practical deployment.

### TECHNICAL FIELD

Embodiments generally propose a method for automated moderation of child-inappropriate video content on cyberspace, leveraging artificial intelligence and computer vision techniques. This method can be applied within content moderation systems employed by online video platforms and social media networks.

### BACKGROUND OF THE INVENTION

The growing popularity of online video-sharing platforms has led to an increasing demand for technological solutions that can identify and block videos containing inappropriate content for children, such as violence, pornography, or promotions of prohibited products like alcohol and tobacco.

Traditionally, video content moderation has been a manual process, with human moderators directly reviewing user-uploaded videos. However, the sheer volume of videos uploaded daily makes this approach labor-intensive, time-consuming, and prone to mistakes.

Therefore, developing and applying technology to assist human moderators in video content moderation is crucial. By applying technologies to filter out a large volume of potentially harmful videos, moderators can reduce the workload and time requirement. They can review the machine-filtered videos and make final decisions regarding the removal or retention of flagged content. The embodiments address the need for an automated method for moderating child-inappropriate video content online with high accuracy and optimal processing time, thus enabling rapid and precise human moderation.

### BRIEF DESCRIPTION OF METHOD

Embodiments propose a new method for the automated moderation of child-inappropriate video content. The method relies on computer vision technology (i.e., image processing, excluding audio analysis) to detect videos that may contain harmful or inappropriate imagery that could negatively impact on the mental and physical well-being of children.

The method comprises the following steps:

Step 1: Collecting and labeling video data on child-inappropriate content: this step involves defining the scope of the task, collecting, and constructing a dataset to train the deep learning model.

Step 2: Data preprocessing: this step is performed using image and video preprocessing algorithms, such as video segmentation, frame resizing, and sampling rate adjustment, to standardize the input data.

Step 3: Building a model to identify time intervals where child-inappropriate objects appear: these objects include but are not limited to, alcohol, beer, tobacco, guns, ammunition . . . ; this step is performed using an object detection model, which classifies and locates objects in each frame, in combination with an object tracking model.

Step 4: Building a model to identify time intervals containing child-inappropriate actions/behaviors: these actions/behaviors include but are not limited to, fighting/violence, pornography, gambling . . . ; this step is performed using a three-dimensional convolutional neural network (3D-CNN) model, which classifies and determines the timing of relevant actions/behaviors.

Step 5: Building a model to determine the age of subjects based on their faces appearing in the frame (if people are present): this step is performed using a two-dimensional convolutional neural network (2D-CNN) model, which can distinguish the age of human face, in combination with a subject tracking model.

Step 6: Post-processing: this step is performed by analyzing the identified time intervals during which child-inappropriate objects, actions/behaviors and the presence of children appear within the entire video, thereby outputting alert for the censors.

Step 7: Optimizing the model performance to minimize video processing latency in practical deployment scenarios: this step is accomplished through the application of model transformation and compression techniques adapted to the specific deployment hardware.

### BRIEF DESCRIPTION OF THE DRAWINGS

FIG. 1 is an illustration depicting the method for automated moderation of child-inappropriate video content on cyberspace.

FIG. 2 is an illustration depicting the step of identifying time intervals with child-inappropriate objects.

FIG. 3 illustrates the step of determining the age of subjects based on their faces appearing in the frame (if people are present).

### DETAILED DESCRIPTION

The proposed method is described in detail below with reference to the drawings, which are intended to illustrate the embodiments and are not intended to limit the scope claims.

The description also refers to a number of existing concepts or formulas used in the field of Computer Science and Artificial Intelligence. However, some of the formulas are self-included to indicate how to apply those in the embodiments. The terms of “YOLO”, “X3D”, “IOU”, “TensorRT”, “Global Pooling”, “ConvNext”, “CORN” are proper nouns, which are the name of the model, algorithm or dataset.

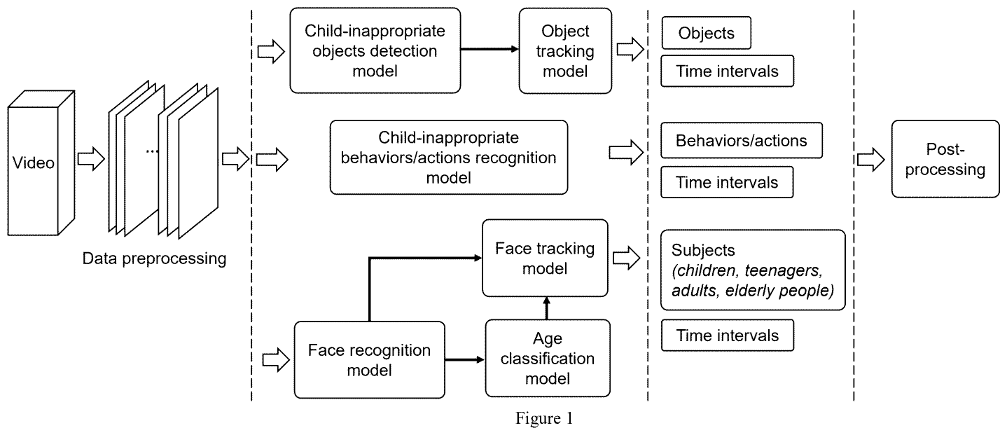

The overview of logical components and pipeline of the proposed method is illustrated in FIG. 1:

Step 1: Collecting and labeling video data on child-inappropriate content;

This step aims to define the scope of the task, identify, and compile a representative dataset to train the deep learning model. First, the scope of child-inappropriate content addressed in this invention includes:
Violent content videos: fighting, killing, using weapons.
Scary content videos: horror, blood, corpses.
Sexual content videos: revealing clothing, nudity or semi-nude, pornography, sexuality.
Prohibited objects for children in videos: cigarettes, alcohol, beer, guns, bullets, sex toys, and drugs.
Gambling content videos: card playing, online gambling, online betting.

The sample video data is collected thematically from the internet, based on the defined scope of work. There are two types of data labeling: object labeling on individual frames and temporal labeling on videos. The labeling tool utilized was CVAT (Computer Vision Annotation Tool), chosen for its capability to label both the video as a whole and its individual frames simultaneously.

For object labeling on frames (images): child-inappropriate object categories are assigned labels, for example: gun, bullet, knives, swords, cigarette, alcohol, beer, sex toys, various drugs . . . . The labeling tool allows for drawing rectangular bounding boxes around objects and assigning labels to them (e.g., “gun”). The minimum required accuracy for labeling is 99%, and the Intersection over Union (IOU) ratio (the intersection area divided by the union area, between the bounding box drawn by the labeler and the ground truth bounding box) when labeling is as follows:
For object size ≥40×40 pixels: IOU≥85%.
For object size <40×40 pixels: IOU≥70%.

For temporal labeling on videos: child-inappropriate behaviors/actions are assigned labels, for example: fighting, violence, pornography, gambling. . . . The labeling tool allows for marking the start and end times of such behavior/action segments within the video, accurate to two decimal places after the second unit, and selecting the appropriate label for that behavior/action.

Step 2: Data preprocessing;

In this step, there are two procedures of data preprocessing, including:

For image input preprocessing: Frames are extracted at a sampling frequency of 8 (i.e., one frame is taken every eight consecutive frames) to reduce noise and increase processing speed by eliminating relatively similar frames. Subsequently, the frames are resized to 416×416 pixels and normalized to a standard normal distribution N (0, 1) to match the input requirements of the model in step 3.

For video input preprocessing: The video is segmented into smaller clips of 4 seconds, with a sliding window step of 2 seconds (i.e., a new 4-second clip is created every 2 seconds). Based on empirical calculations, a 4-second clip provides sufficient information about a specific behavior/action, while the sliding window step ensures temporal continuity between consecutive clips, preventing the omission of suspicious actions/behaviors. Subsequently, frames within each clip are extracted at a sampling frequency of 4, resulting in 16 frames per clip, reducing noise and increasing processing speed by eliminating relatively similar frames. Finally, the clips are resized to 224×224 pixels per frame and normalized to a standard normal distribution N (0, 1) to match the input requirements of the model in step 4.

Step 3: Building a model to identify time intervals where child-inappropriate objects appear;

The objects determined to be prohibited are based on the scope defined in Step 1. A deep learning model with object detection capabilities is built upon the YOLO base model. This model is trained and fine-tuned using the labeled dataset from Step 1.

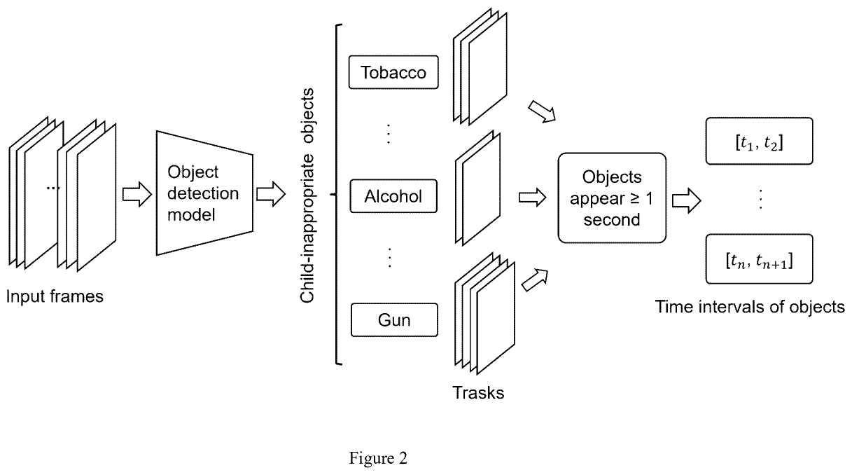

To reduce false object detections, a simple object tracking model is proposed as follows: an initial track is created for each type of object appearing for the first time in a frame. The object tracking model is applied without storing individual object IDs, but rather tracks based on object class, eliminating a significant amount of computation without decreasing accuracy. Additionally, the maximum number of tracks is the number of object classes, minimizing storage requirements. To prevent objects from being lost due to occlusion, if the model does not detect an object after 3 seconds, the corresponding track for that object type is terminated. Finally, to ensure accuracy, the model only return the time intervals during which the child-inappropriate object appears greater than or equal to 1 second. This step is illustrated in FIG. 2.

Step 4: Building a model to identify the time intervals where child-inappropriate behaviors/actions appear;

The child-inappropriate behaviors/actions are based on the scope defined in Step 1. A deep learning model using a three-dimensional convolutional neural network is proposed for behavior/action recognition. In this model, in addition to two spatial feature extraction dimensions, a third dimension is added to extract temporal features from the video. The input of the model are small video clips with a length of 4 seconds, extracted using a sliding window with a 2-second step size. An attention mechanism is implemented to effectively extract spatial-temporal features within the video, based on the X3D base model. The model is fine-tuned with appropriate parameters during training on the labeled dataset of behaviors/actions from Step 1.

Step 5: Building a model to determine the age of the subject based on their face appearing in the frame (if a person is present);

This step aims to identify the time intervals during which children appear in the video, providing supplementary information in determining whether the video content is related to children.

First, a model is proposed to locate and identify faces within the frame. The model is trained and fine-tuned with appropriate parameters based on the YOLO model. It returns the location of each person's face, and face images are then cropped if their size is ≥40×40 pixels. These cropped face images are then aligned to a balanced position. Finally, they are resized to 112×112 pixels and normalized to fit the input of the age classification model.

Next, a two-dimensional convolutional neural network (CNN) model is used to classify subjects by age based on their face. The model can distinguish between four age groups: children, teenagers, adults, and elderly people. The ConvNext base network architecture is used for facial feature extraction, followed by a Global Pooling layer to reduce the feature map dimension. The features are then flattened into a feature vector and passed through a classification layer. Due to the ordinal nature of the data (face ages ranging from young to old), the proposed model employs the CORN loss function (Conditional Ordinal Regression for Neural Networks-CORN), commonly used in ordinal regression, instead of the typical classification loss function. The CORN loss function applies the chain rule in probability to avoid the rank inconsistency issue often encountered in ordinal regression. For each age group, arranged from youngest to oldest, the model outputs probability that the subject is older than the current age group, given that the subject's age is older than the previous age groups. These probabilities are then transformed using CORN to return to the correct age of the subject.

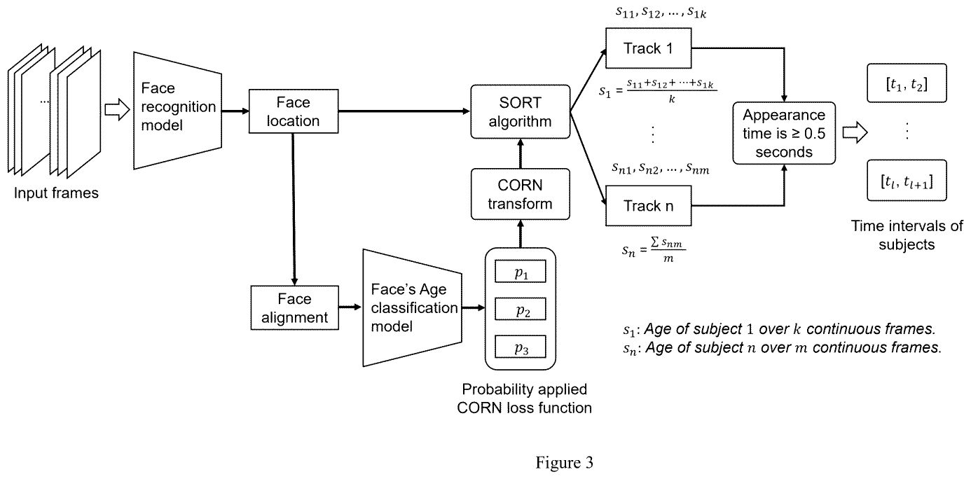

Since faces at different angles can yield varying age results, to mitigate noise, the SORT object tracking algorithm is proposed. The accurate age of a subject is calculated by averaging the predicted ages of the subject throughout a track. If the result is below a certain threshold, the subject is identified as a child or teenager. Based on experiments and empirical calculations, the threshold is set at 0.9. As videos may contain scenes that transition rapidly within short periods, to ensure model accuracy, the result for a subject is only considered if the appearance time is ≥0.5 seconds. This step is illustrated in FIG. 3.

Step 6: Post-processing the output information to provide review results;

The purpose of this step is to aggregate information about the time intervals during which objects, behaviors/actions, and subjects appear in the video to review and conclude whether the video content contains elements that require warning or intervention.

In practice, when deploying a video content moderation system, videos uploaded by users on platforms and social networks are passed through automated content moderation software. This software integrates the trained models described in the previous steps. The output returns time intervals with warnings: prohibited objects, suspicious behaviors/actions requiring intervention, and the presence of children or teenagers. The system can be configured to automatically block videos or to allow reviewers to review and make a final decision.

Step 7: Optimizing the performance of the models to reduce video processing time in practical deployment;

The deep learning models in this method are all converted and compressed using the TensorRT library, aiming to reduce the size and processing time of the input video. This enhances performance in practical deployment scenarios.

While the above descriptions contain many specific details, they are not intended to limit the scope of the invention's implementation, but rather to illustrate some preferred embodiments.

1. A method for automated moderation of child-inappropriate video content includes the following steps:
Step 1: collecting and labeling video data containing child-inappropriate content; this step is carried out based on a defined scope of work, building a dataset for training a deep learning model;
a scope of child-inappropriate content includes: (1) violent content videos: fighting, killing, using weapons; (2) scary content videos: horror, blood, corpses; (3) sexual content videos: revealing clothing, nudity or semi-nude, pornography, sexuality; (4) prohibited objects for children in videos: cigarettes, alcohol, beer, guns, bullets, sex toys, and drugs; (5) gambling content videos: card playing, online gambling, online betting;
Step 2: data preprocessing; this step is performed based on image and video preprocessing algorithms such as video cropping, frame resizing, and resampling, to standardize the input data;
Step 3: building a model to identify time intervals of an appearance of child-inappropriate objects; this step is performed based on an object detection model, which can classify and locate objects in each frame, combined with an object tracking model;
Step 4: building a model to identify time intervals of occurrence of child-inappropriate behaviors/actions; this step is performed based on a three-dimensional convolutional neural network (3D-CNN) model, which can classify and determine the occurrence time of relevant behaviors/actions;
Step 5: building a model to identify the age of the subjects based on their face appearing in a frame; this step is performed based on a two-dimensional convolutional neural network (2D-CNN) model, which can distinguish the age of human face, combined with a subject tracking model;
Step 6: post-processing the output information to produce censorship results; this step is performed based on results of the time intervals of the appearance of child-inappropriate objects, actions/behaviors, and children (if any) on an entire video, thereby providing warnings to the censors;
Step 7: optimizing the model performance to reduce video processing time for practical deployment; this step is performed based on model transformation and compression techniques suitable for deployment of hardware.

2. The method for automated moderation of child-inappropriate video content according to claim 1, wherein:
in step 1, video data containing content inappropriate for children is collected thematically from the internet based on the defined scope; there are two types of data labeling: object labeling on images (frames) and time labeling on videos; CVAT (computer vision annotation tool) labeling tool is chosen for its capability to label both the video as a whole and its individual frames simultaneously;
for object labeling on images: child-inappropriate object categories are assigned labels, including: guns, ammunition, knives, swords, cigarettes, alcohol, beer, sex toys, drugs, etc.; the labeling tool allows drawing a rectangular bounding box around the object, selecting a label for that object), with a requirement of a minimum correct labeling rate of 99%, and an IOU (intersection over union, between the rectangular bounding box drawn by the labeler and a standard bounding box) as follows: for object size ≥40×40 pixels: IOU≥85%; for object size <40×40 pixels: IOU≥70%;
for time labeling on videos: child-inappropriate behaviors/actions are assigned labels, including fighting, slashing, pornography, gambling, etc.; the labeling tool allows for marking a start and end time of the segment of that behavior/action in the video, up to two decimal places after a second unit, and selecting a label for that behavior/action.

3. The method for automated moderation of child-inappropriate video content according to claim 1, wherein:
in step 2, there are two procedures of data preprocessing, including:
for image input preprocessing: frames are extracted with a sampling rate of 8 (i.e., one frame is taken every eight consecutive frames), aiming to reduce noise and increase processing speed by removing relatively similar frames; then, the frames are resized to 416×416 pixels and normalized to the standard normal distribution N (0, 1) to be suitable for the input of the object detection model (step 3);
for video input preprocessing: the video is cut into small video segments with a duration of 4 seconds with a sliding window step of 2 seconds (i.e., a 4-second video is cut every two seconds); based on experimental calculations, a small video length of 4 seconds is sufficient to provide information about a certain behavior/action occurring, and the sliding window step represents a continuity between the previous and subsequent video segments over time, ensuring that no suspicious actions/behaviors are missed; then, frames within each small video segment are extracted with a sampling rate of 4, so each small video segment will be equivalent to 16 frames, aiming to reduce noise and increase processing speed by removing relatively similar frames, finally, the small video segments are resized to 224×224 pixels and normalized to a standard normal distribution N (0, 1) to be suitable for the input of the behavior/action detection model (step 4).

4. The method for automated moderation of child-inappropriate video content according to claim 1, wherein:
in step 3, a deep learning model for object detection is built based on the YOLO base model, trained and fine-tuned with appropriate parameters on the labeled dataset from step 1;
to reduce false object detection, a simple object tracking model is used in combination as follows: initialize a track for each object type appearing in the frame for a first time; the object tracking model saves tracks based on object type, eliminating a large amount of computation without reducing accuracy; besides, the maximum number of tracks is the number of object types, helping to minimize storage memory, to avoid cases where objects are lost due to occlusion, if the model does not detect an object after 3 seconds, the tracking corresponding to that object type will be canceled; finally, to ensure accuracy, the model only returns output if the object to be inappropriate appears in the tracking period ≥1 second.

5. The method for automated moderation of child-inappropriate video content according to claim 1, wherein:
in step 4, a deep learning model with a three-dimensional convolutional neural network (3D-CNN) is utilized for behavior/action recognition, in addition to the two dimensions for extracting spatial features, a third dimension is added to extract temporal features from the video; this model takes input as small video clips with a duration of 4 seconds, with a sliding window step of 2 seconds; the proposed model incorporates an attention mechanism to effectively extract spatial-temporal features in the video, based on a X3D base model; the model is trained and fine-tuned with appropriate parameters on the dataset of labeled behaviors/actions from step 1.

6. The method for automated moderation of child-inappropriate video content according to claim 1, wherein:
in step 5, a deep model for detecting and locating faces in the frame is utilized, the model is trained and fine-tuned with appropriate parameters based on the YOLO base model; the model returns a face location of each person, and face images are cropped if a face size is ≥40×40 pixels, then aligned to a balanced position; finally, the face images are resized to 112×112 pixels and normalized to be suitable for the input of the subject's age classification model;
next, a two-dimensional convolutional neural network (2D-CNN) model is used to classify subjects by age based on their faces; the model can distinguish four types of objects: children, teenager, adult, and elderly people; the model uses a ConvNext base network architecture to extract facial features, followed by a global pooling layer to reduce the feature map dimension, then flattens it into a feature vector and passes it through a classification layer; due to the ordinal nature of the data (face ages ranging from young to old), the model utilizes a CORN loss function, applied in ordinal regression instead of the usual classification loss function; the CORN loss function applies a chain rule in probability to avoid a rank inconsistency problem often encountered in ordinal regression; in this case, for each type of object by age arranged from young to old, the model will return probabilities that the object is older than an age being considered, given that the object's age is older than the previous ages; these probabilities will then undergo CORN transformation to return a correct age of the object;
since faces at different angles can return varying age results, to reduce noise, a SORT object tracking algorithm is used; an accurate age of an object will be calculated by averaging a predicted age of the object throughout a track, if the result is below a certain threshold, it will be determined as a child or teenager; based on experiments and empirical calculations, the threshold is chosen as 0.9;
since the video may contain scenes that are continuously switched in a short period, to ensure the accuracy of the model, only the results of an object are taken if the appearance time is ≥0.5 seconds.

7. The method for automated moderation of child-inappropriate video content according to claim 1, wherein:
in step 7, all deep learning models in this method are converted and compressed using a TensorRT library, aiming to reduce the size and processing time of the input video.
